(19) United States
(12) Patent Application Publication
(10) Pub. No.: US 2012/0186372 A1
(43) Pub. Date: Jul. 26, 2012

(54) Oscillating device and process for drilling holes in soft materials

(76) Inventors: RONALD D. SMITH, ANDERSON, IN (US); MARK A. NOFFSINGER, MATTAWAN, MI (US)

(21) Appl. No.: 13/427,360

(22) Filed: Mar. 22, 2012

Related U.S. Application Data
(63) Continuation-in-part of application No. 12/151,856, filed on May 9, 2008.

(51) Int. Cl. F16H 21/18

(52) U.S. Cl. 74/42

(57) ABSTRACT

A simple mechanical device that converts the rotary motion of a drill motor to an oscillating/reciprocating or into a continuous motion. The device is for use in operations with soft, fibrous materials such as surgical needs, carpets, fiber based materials, and soft woods. The device drills a close tolerance hole with drive shafts in line or offset to the driven shaft. A general reciprocating drive system is comprised of a reciprocating drive device; a turning drive device such as a drill; a drive structure member such as a gear, plate or the like; a reciprocation configuration such as the eccentric linkage; a device encasement; a means for connecting the members to an encasement; a control mechanism for reciprocating or continuous rotation; a driven output connector such as a tool chuck; and a drill bit with at least 3 flutes.

### CROSS-REFERENCE TO RELATED APPLICATIONS

This application is a Continuation-in-Part filed under 37 CFR 1.53(b) and claims the benefit of the original non-provisional (Regular Utility) U.S. patent application Ser. No. 12/151,856 submitted May 9, 2008 and Published Feb. 26, 2009 as US 2009/0050343 A1. Both the application and publication are entitled a “Process and apparatus for drilling holes in soft materials” and were submitted by Ronald Smith and Mark Noffsinger. The original application is incorporated fully by reference as if it were reproduced here, verbatim.

### FIELD OF INVENTION

This invention relates to a simple mechanical device that converts the rotary motion of a drill motor to an oscillating or reciprocating motion. This is proposed for various uses including surgical applications. This invention is an oscillating device and process for drilling holes in soft materials. The new mechanism allows one to change from pure rotatory drill to an oscillating device to drill for soft materials. Several prototypes have been built to successfully test different shaft geometry, varying drill bits, and degrees of rotation of the bit. They have been tested and found to solve the problems described. One model rotates about 120 to 130 degrees and uses a three fluted drill. The device drills a close tolerance hole and the use of at least a three flutes help make up for the speed lost while the bit is reversing. The three fluted bits are sometimes difficult to find and relatively a little more costly than a two flute type. Another model rotates about two hundred (200) degrees and uses a standard twist drill bit. Empirically it also works quite well. The other variation of the prototypes was in the geometry of the input shaft and the output shaft. Versions or embodiments have the shafts in line, offset and electronically accomplished. These were done for application convenience. In addition, an alternative embodiment includes a switch to also go to a continuous clockwise direction without oscillation and a reverse (counterclockwise movement) in a continuous direction.

### FEDERALLY SPONSORED RESEARCH

None.

### SEQUENCE LISTING OR PROGRAM

None.

### BACKGROUND—FIELD OF INVENTION

Various drills over the ages have tried to address the need to drill safely through soft materials. The surgical field has addressed soft tissues for wire insertion but did not anticipate other surgical drilling needs and various non-medical uses for a reciprocating or oscillating drill device.

A. Introduction of the Problems Addressed

Drilling through soft materials such as carpets, foam rubber, upholstery fabrics, insulations etc. is very difficult if not dangerous because drill bits tend to catch on these materials and get wrapped around the bit which can cause unintended damage to the material and/or twist the drill motor out of the operator's hands. Orthopedic surgeons have had the same kind of problems when drilling in bones. If tissue comes in contact with the drill bit, it can get wrapped around the bit and cause considerable tissue and/or muscle damage.

Several prototypes have been built to successfully test different shaft geometry, drill bits, and degrees of rotation of the bit. They have been tested and found to solve the problems described. One model rotates about 120 to 130 degrees and uses a three fluted drill. The device drills a close tolerance hole and the “at least” three or more flutes help make up for the speed lost while the bit is reversing. The “at least” three or more fluted bits are sometimes difficult to find. Another model rotates about two hundred (200) degrees and uses an at least three fluted bit for precision drilling or a standard twist drill bit when accuracy is not a requirement. Another variation of the prototypes is in the geometry of the input shaft and the output shaft. Still another alternative embodiment includes a switch to also go to a continuous clockwise direction without oscillation and a reverse (counterclockwise movement) in a continuous direction. Other versions or embodiments have the shafts in line, offset and electronically accomplished. These were done for application convenience upon logical and empirical considerations.

B. Prior Art

An example of a process and apparatus for drilling holes in soft materials, in non-surgical procedures was shown by U.S. Pat. No. 4,111,208 (FIG. 8A) issued to Leuenberger on Sep. 5, 1978. This taught a process and apparatus for drilling holes in hard materials in surgical procedures, comprising driving a drilling tool with a movement of alternating rotation with an amplitude of less than one revolution. The tool can be driven from a motor having unidirectional continuous rotatable movement through a convertor which transforms this movement into the alternating rotation. The drilling tool can covered by a member which feeds the waste cutting materials rearwardly into an enclosed chamber. The apparatus can also be provided with a member that covers the drill during an insertion thereof through cut tissue prior to the drilling operation. This Smith drill does not limit itself to surgical or non-surgical uses.

A U.S. Pat. No. 4,955,888 (FIG. 8B) issued to Slocum (1990) teaches a biradial saw including a biradial saw blade having an elongate, arcuate body with a cutting end that is constructed to penetrate a solid substance. The blade's body is formed with inner and outer arcuate surfaces whose curvature radii are substantially equal but oriented relative to offset axes of curvature. Also included is a means for producing oscillating motion, and a means for attaching the blade's rear end to the oscillating-motion-producing means.

A radiolucent orthopedic chuck was shown and taught by the U.S. Pat. No. 5,030,222 (FIG. 8C) issued to Calandruccio, et al. (1991). The patent taught a radiolucent orthopedic chuck includes a housing having a driver stem protruding from the top surface and a drill bit protruding from the underside in radially spaced relation from the driver stem so as to displace a drill secured to the driver stem from the axis of the drill bit so that fluoroscopy may be used to ensure accurate alignment of the drill bit with a hole of an intramedullary nail both prior to and during its operation. A drive train interconnects the driver stem and drill bit for rotation in unison. All parts of the chuck but for the drill bit are preferably radiolucent. In the Smith device, for any “non-radiolucent” applications, ball bearings may be interchanged for radiolucent compatible bushings.

A Method of fixating bone by driving a wire through oscillation was taught by the U.S. Pat. No. 6,110,174 (FIG. 8D) issued to Nichter (2000). The patent taught a method and/or apparatus is provided for bone fixation which includes oscillating a wire about a longitudinal axis, advancing the oscillating wire into the bone tissue, and leaving the wire in the bone tissue as a fixation element. The apparatus in the present invention may be a self-contained unit for providing oscillatory motion to a chuck configured for releasably engaging a K-wire or the like, or may include a drive gear for use with a conventional rotor and drill for accomplishing the same oscillatory action. Nichter discloses a general reciprocating drive system, but is in a scope different from the Smith method and device. It shows and teaches a rotating wire driver (not used a three or more fluted drill bit as by Smith)) that is transformed to a specific reciprocating motion. Smoothness and precision is undefined. The Nichter use described is as for fixation into bone and placing a k wire to avoid damage to tissues and nerves. Nichter has limited tool use with the wire system and fails to show the same scope and capabilities as Smith's method and device. Smith's continuation application shows specific tool usage to improve the ability to drill into soft materials and to hold a precision diameter if needed. Smith also shows the ability to alternatively run as a continuous rotation in either the clockwise or counter clockwise direction. Other enhancements and differences will be apparent to one skilled in drive systems from the description below and the accompanying reference drawings. The components and combination shown by Nichter do not anticipate, do not teach, nor are specifically or functionally equivalent to the Smith's continued invention.

A reciprocating saw was taught by the U.S. Pat. No. 4,145,811 issued to Kendzior (1979). A reciprocating blade saw wherein the counterbalancing of the drive system includes the provision of two directly opposed and coaxial rams, one attached to the saw blade and the other having 1II mass equal to the first ram plus the blade, both being attached to a crankshaft by links which have their masses symmetrically distributed. The crankshaft is driven by a hydraulic motor, and all the masses are so matched that the saw is in balance at all speeds and can be operated at high speeds with minimal vibration. The saw is designed for use particularly in the meat industry. The type of apparatus—a saw—is non-analogous to rotational drivers. It neither anticipates nor obviates the Smith method and device.

An anti-vibration adaptor was taught by the U.S. Pat. No. 6,321,855 issued to Barnes (2000). It teaches a Power drivers are commonly used in production to tighten fasteners such as nuts and bolts. It relates only as to ways to possibly encase a handheld device and is otherwise totally non-analogous to Smiths invention.

As far as known, there are no known devices at the present time on the market that can effectively drill through these materials and also effectively drill through wood, bones, aluminum, copper, steel, etc. It is believed that this device is made with fewer parts, of a more durable design, and with comparatively less expense as compared to other drill and turning devices for soft materials in use today.

### SUMMARY OF THE INVENTION

This invention relates to a simple mechanical device that converts the rotary motion of a drill motor to an oscillating or reciprocating motion. This is proposed for various uses.

The preferred embodiment of the device is a general reciprocating drive system made of durable material comprising (a) a reciprocating drive means 32 for transferring rotational movement to reciprocating movement comprising a direct rotational drive means 34 for imparting rotational movement to the system 31, a means for connecting 34A the direct rotational drive means 34 to the system 31,a transfer means 35 inter-placed between the direct rotation drive and a reciprocation means 41, a reciprocation means 36 for transforming rotational movement to reciprocating movement; an output means to connect 41 for supplying reciprocating movement; and means for connecting the output to a tool 41A; (b) a durable encasement 40; (c) a means for connecting 39 the components of the drive means 31 to the encasement means 40; and (d) a means 45 for holding the encasement whereby the rotational drive motion is smoothly transferred into a reciprocating motion to use for turning and drilling soft materials by a person P operating the system. An alternative embodiment is the system according to claim 1 wherein the direct rotational drive means 34 is comprising (a) a power source, (b) a means for controlling the power source, (c) a rotating drive motor, and (d) a means for completing an electrical connection the power source and the controlling means to the electrical motor.

The newly invented drilling device and system features various configurations to accomplish the desired output within the scope and spirit of the unique device and new use described herein.

### OBJECTS AND ADVANTAGES

There are several objects and advantages of the drilling device and process. There are currently no known turning or drill devices that are effective at providing the objects of this invention. The following TABLE A summarizes various advantages and objects of the drilling device and system. This list is exemplary and not limiting to the many advantages offered by this new device.

TABLE A
Various Advantages and Objects

| Item | Description of Advantage |
|---|---|
| 1 | Smooth operation of turning |
| 2 | No chatter |
| 3 | Durable |
| 4 | Multi-use |
| 5 | Simple |
| 6 | Straight or Offset Design |
| 7 | Mechanically simple |
| 8 | Minimizes wobble without Ball Bearings |
| 9 | Bearings/Drill bit retainer block would be |
| | inexpensive and easy to replace by user |
| 10 | Uses the same power supply as the existing drill and |
| | would be interchangeable with it |
| 11 | Do not have to attach a drill motor |
| 12 | Less awkward |
| 13 | Easily adjusts to differing torque and speed |
| | requirements |
| 14 | Could have handles for left and right hand operations |
| | and convenience |
| 15 | Different sized drill bits would require different |
| | bearing/retainer blocks unless the drill bits were |
| | made with the same sized upper shank |
| 16 | Bevel gear or other gears is molded onto the drill bit |
| | or modified to have a permanent gear |
| 17 | Future design changes or operating charges would be |
| | easily incorporated |
| 18 | Is Sterilizable |
| 19 | Is Radiolucent if necessary |
| 20 | Is Quiet |
| 21 | Adapts to different sizes and styles of bits |
| 22 | Removes material instead of inserting a wire |
| 23 | Uses a minimum of a three fluted (tri fluted) bit to |
| | make a round hole |
| 24 | Can be switched from oscillating to continuous |
| 25 | Provides a means of drilling into hard material |
| | covered in softer material without having to remove or |
| | significantly alter the soft covering (e.g. to allow |
| | for placement of securing device or passing of wires, |
| | pipes, ventilation, etc. |

Finally, other advantages and additional features of the new oscillating device and process for drilling holes in soft materials will be more apparent from the accompanying drawings and from the full description of the device. For one skilled in the art of devices and improvements for turning and drilling devices, it is readily understood that the features shown in the examples with this mechanism are readily adapted for improvement to other types of turning and drilling devices and systems.

### DESCRIPTION OF THE DRAWINGS—FIGURES

The accompanying drawings, which are incorporated in and constitute a part of this specification, illustrate a preferred and alternative embodiments for the drilling device and system. The drawings together with the summary description given above and a detailed description given below serve to explain the principles of the drilling device and system. It is understood, however, that the device is not limited to only the precise arrangements and instrumentalities shown.

FIGS. 1A and 1B Elements of general reciprocating drive system and directional rotation drive sub-system for the oscillating device and process for drilling holes in soft materials.

FIGS. 2A and 2B are sketches of the reciprocating drive device—offset drive and eccentric bars.

FIGS. 3A and 3B are additional sketches of the reciprocating drive device—offset drive and eccentric bars.

FIGS. 4A and 4B are sketches of the reciprocating drive device—inline drive and eccentric bars.

FIGS. 5A through 5E are sketches of the reciprocating drive device—inline drive, gears and eccentric bars and combination reciprocating drive and continuous drive sub-system.

FIGS. 6A and 6B are sketches of the electronic controlled reciprocating turning device such as a drill or the like.

FIGS. 7A and 7B are sketches that show the problem addressed.

FIGS. 8A through 8D are prior art of other turning devices.

FIGS. 9A through 9C are tooling option specifics to drill bits.

### DESCRIPTION OF THE DRAWINGS—REFERENCE NUMERALS

The following Table B refers to the drawings:

TABLE B
Reference numbers

| Ref # | Description |
|---|---|
| 31 | General oscillating device and process for drilling holes in |
| | soft materials |
| 32 | Reciprocating drive device—offset drive and eccentric bars |
| 33 | Reciprocating drive device—inline drive and eccentric bars |
| 33A | Reciprocating drive device—inline drive, gears and |
| | eccentric bars |
| 34 | Rotational Turning drive means such as a drill |
| 34A | Means to connect drive to transfer member |
| 35 | Drive transfer member such as a gear, plate or the like |
| 35A | Intermediate driven structure member such as a gear, plate, |
| | linkage or the like |
| 36 | Reciprocation configuration of members |
| 37 | Eccentric linkage |
| 37A | Secondary linkage |
| 38 | Reciprocating driven structure member such as a gear, plate, |
| | linkage or the like |
| 39 | Connection means of members to an encasement - such as a |
| | thrust bearing or the like |
| 40 | Device encasement or outer shell |
| 41 | Driven output means such as a reciprocating shaft |
| 41 | Means to connect output means to tool or tool chuck |
| 42 | Intermediate structure mounting means |
| 45 | Device support handle |
| 46 | Example of reciprocating drill |
| 47 | Simple fluted drill bit |
| 48 | Simple bi-radial saw |
| 49 | Example of a rotating gear drive |
| 50 | Reciprocal gear and eccentric linkage |
| 51 | Turning means such as a drill with reciprocating output |
| 52 | Electronically controlled reciprocating component |
| 53 | Electronics control |
| 54 | Tool chuck means |
| 55 | Electronic controlled reciprocating turning device such as a |
| | drill, drive motor or the like |
| 56 | Operating switch |
| 57 | Single fiber wrapping around rotating tool |
| 58 | Multiple fibers not wrapping around reciprocating tool |
| 59 | Reversing switch |
| 70 | Transmission with longitudinal adjust for the output shaft |
| 71 | Continuous Drive output gear |
| 72 | Continuous Drive input gear |
| 73 | Continuous Drive shaft |
| 77 | Shift movement for oscillating/continuous drive transmission |
| | system |
| P | Operator or person |
| 80 | Flutes |
| 81 | Flute length |
| 82 | Body length |
| 83 | Helix angle |
| 84 | Neck |
| 85 | Shank diameter |
| 86 | Shank length |
| 87 | Land width |
| 88 | Point angle |
| 91 | a power source |
| 92 | a means for controlling the power source |
| 93 | a rotating drive motor |
| 94 | a means for completing an electrical connection the power |
| | source and the controlling means to the electrical motor |
| 95 | Three fluted drill |
| 95A | Three fluted drill part photo to sketch |
| 95B | Three fluted drill end view with flutes |
| 95XB | Three fluted drill expanded end view |

### DETAILED DESCRIPTION OF PREFERRED EMBODIMENT

The present invention is an oscillating device and process for drilling holes in soft materials that has been developed for use by a person to provide a method to drill through soft and fibrous materials in various uses. The preferred embodiment of the oscillating device for drilling holes in soft materials is a general reciprocating drive system made of durable material comprising (a) a reciprocating drive means 32 for transferring rotational movement to reciprocating movement comprising a direct rotational drive means 34 for imparting rotational movement to the system 31, a means for connecting 34A the direct rotational drive means 34 to the system 31,a transfer means 35 inter-placed between the direct rotation drive and a reciprocation means 41, a reciprocation means 36 for transforming rotational movement to reciprocating movement; an output means to connect 41 for supplying reciprocating movement; and means for connecting the output to a tool 41A; (b) a durable encasement 40; (c) a means for connecting 39 the components of the drive means 31 to the encasement means 40; and (d) a means 45 for holding the encasement whereby the rotational drive motion is smoothly transferred into a reciprocating motion to use for turning and drilling soft materials by a person P operating the system. An alternative embodiment is the system according to claim 1 wherein the direct rotational drive means 34 is comprising (a) a power source, (b) a means for controlling the power source, (c) a rotating drive motor, and (d) a means for completing an electrical connection the power source and the controlling means to the electrical motor. The structural members of the drilling device and system are potentially made of various materials. The device may have alternative embodiments described within this specification.

The improvement over the existing art is providing a device that is: A smooth operation of turning; has limited or no chatter; is durable; has multi-uses; is simple; may be configured with a straight or offset Design; is essentially mechanically simple; minimizes wobble without ball bearings; has bearings or drill bit retainer block that may be inexpensive and easy to replace by user; uses the same power supply as the existing drill and would be interchangeable with it; does not have to attach a drill motor; is less awkward; easily adjusts to differing torque and speed requirements; can have handles for left and right hand operations and convenience; may accommodate different sized drill bits would require different bearing/retainer blocks unless the drill bits were made with the same sized upper shank; may have a bevel gear or other gears is molded onto the drill bit or modified to have a permanent gear; adapts easily to future design changes or operating charges for easy incorporation; is sterilizable; is radiolucent if necessary; is quiet; adapts to different sizes and styles of bits; removes material instead of inserting a wire; uses a minimum of a three fluted (tri-fluted) bit to make a round hole; can be switched from oscillating to continuous; and provides a means of drilling into hard material covered in softer material without having to remove or significantly alter the soft covering.

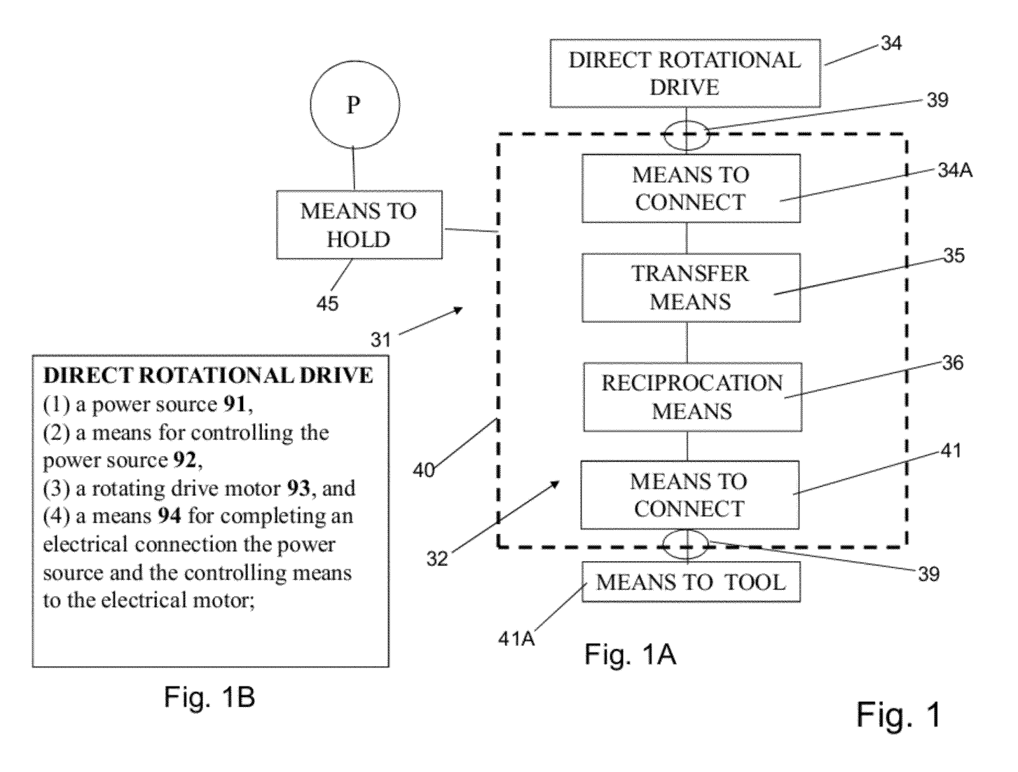

There are shown in FIGS. 1-9 a complete operative embodiment of the oscillating device and process for drilling holes in soft materials along with some prior related art. In the drawings and illustrations, one notes well that the FIGS. 1 through 9 demonstrate the general configuration and use of this invention. The preferred embodiment of the device is comprised of only a few parts as shown in the sketches and drawings. The preferred embodiment of the oscillating device and process for drilling holes in soft materials is essentially a general reciprocating drive system made of durable material comprising (a) a reciprocating drive means 32 for transferring rotational movement to reciprocating movement comprising a direct rotational drive means 34 for imparting rotational movement to the system 31, a means for connecting 34A the direct rotational drive means 34 to the system 31,a transfer means 35 inter-placed between the direct rotation drive and a reciprocation means 41, a reciprocation means 36 for transforming rotational movement to reciprocating movement; an output means to connect 41 for supplying reciprocating movement; and means for connecting the output to a tool 41A; (b) a durable encasement 40; (c) a means for connecting 39 the components of the drive means 31 to the encasement means 40; and (d) a means 45 for holding the encasement whereby the rotational drive motion is smoothly transferred into a reciprocating motion to use for turning and drilling soft materials by a person P operating the system. An alternative embodiment is the system according to claim 1 wherein the direct rotational drive means 34 is comprising (a) a power source, (b) a means for controlling the power source, (c) a rotating drive motor, and (d) a means for completing an electrical connection the power source and the controlling means to the electrical motor. One skilled in the art of drilling devices and systems, especially oscillating types, will appreciate the plethora and varied uses anticipated by this new special drilling device and system. The newly invented drilling device and system features very few parts. In operation, the new device may be easily and quickly used to drill into soft materials in various uses.

Various important features of these components are delineated in FIGS. 1-9 of the sketches and drawings and are described below. The description is in appropriate detail for one skilled in the art to appreciate their importance and functionality to the oscillating device and process for drilling holes in soft materials 31, 32, 33.

The accompanying drawings, which are incorporated in and constitute a part of this specification, illustrate an embodiment of an oscillating device and process for drilling holes in soft materials 31, 32 that is preferred. The drawings together with the summary description given above and a detailed description given below serve to explain the principles of the drilling device and system 31, 32. It is understood, however, that the drilling device and system is not limited to only the precise arrangements and instrumentalities shown. This is exemplified with the described alternative embodiments.

FIGS. 1A and 1B Elements of general reciprocating drive system and directional rotation drive sub-system for the oscillating device and process for drilling holes in soft materials. FIG. 1A shows the elements of general reciprocating drive system. A general oscillating or reciprocating drive system 31 made of durable material. A reciprocating drive means 32 comprising a direct rotational drive means 34; a means to connect to a direct rotational drive means 34A; a transfer member 35; a reciprocation means 36; an output means 41; and means to connect to a tool 41A. The device has an encasement 40; a means to connect 39 the components of the drive means 31 to the encasement means 40; and a means 45 to hold the encasement whereby the rotational drive motion is smoothly transferred into a reciprocating motion to use for turning and drilling soft materials by a person P operating the system. One notes this interconnection system results in a reciprocation configuration 36 of the various members. The reciprocally or oscillating driven structure member 38 is connected to an output means 41 such as a shaft or the like with a means to ultimately connect to a tool or tool chuck 54. FIG. 1B shows the directional rotational drive 34 comprising (1) a power source 91, (2) a means for controlling the power source 92, (3) a rotating drive motor 93, and (4) a means 94 for completing an electrical connection the power source and the controlling means to the electrical motor.

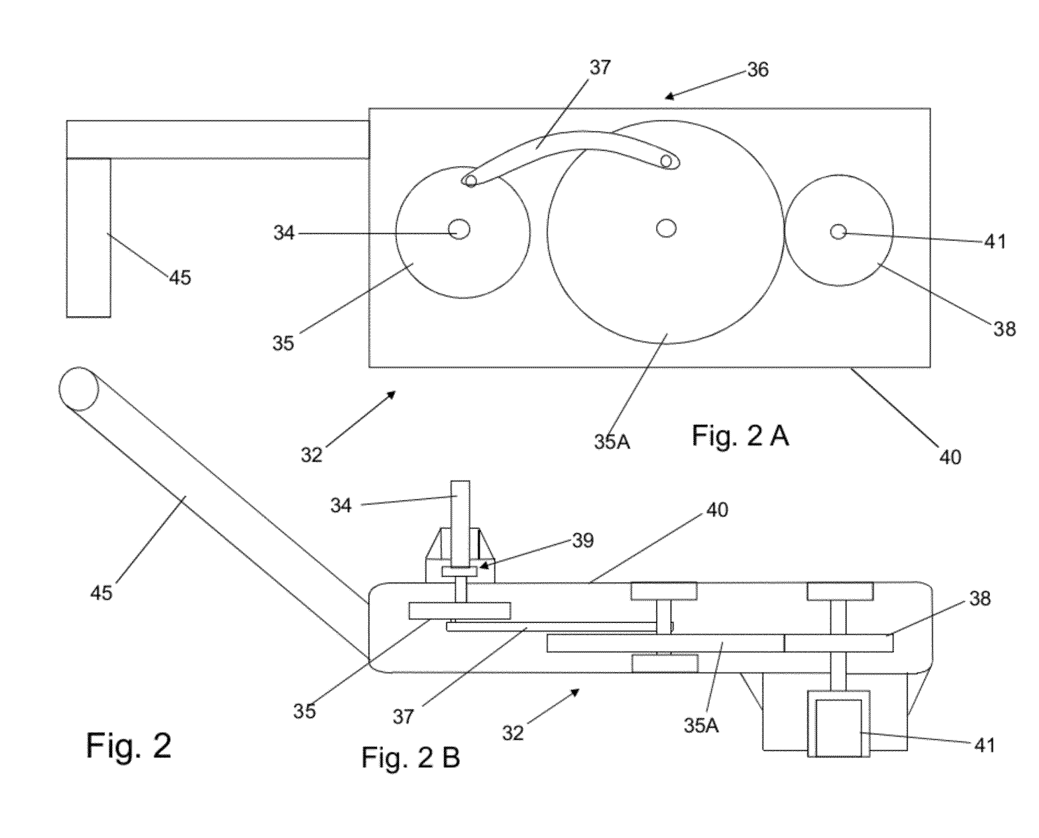

FIGS. 2A and 2B are sketches of a reciprocating drive device 32 with offset drive and eccentric bars. The device is in an encasement 40 with a handle 45. The device 32 is comprised of a drive means 34 secured to a drive structure 35 such as a gear or plate. This structure 35 is eccentrically linked by linkage 37 to an intermediate gear 35A. The driven structure 35A in turn directly drives the output gear 38 which is secured in turn to the output means 41, here a shaft or the like. Note in FIG. 2B one sees that the input means 34 and output means 41 are offset.

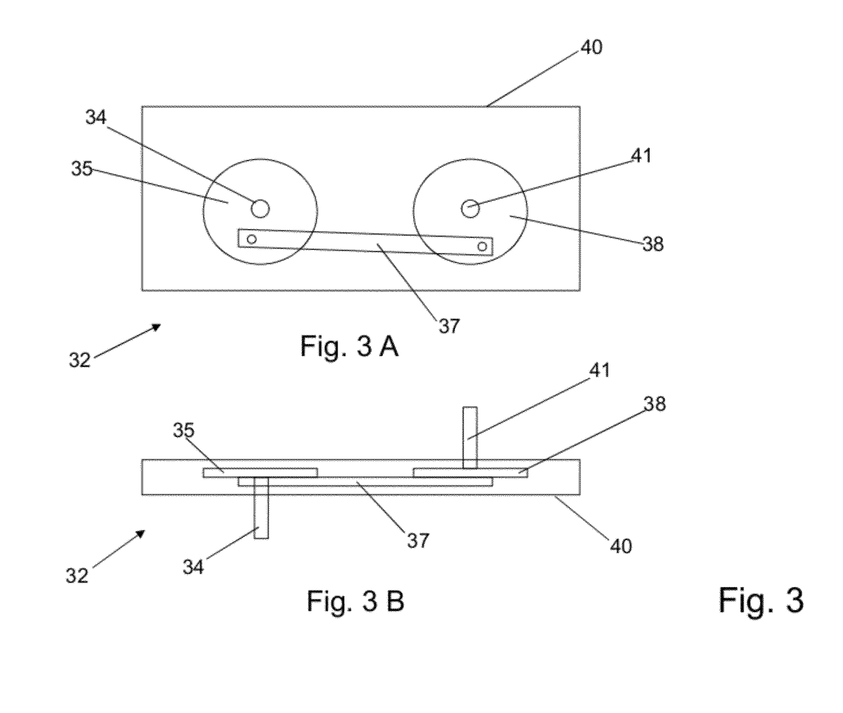

FIGS. 3A and 3B are additional sketches of another reciprocating or oscillating drive device offset drive and eccentric bars. In this view there is no intermediate structure 35A and the drive plate 35 is eccentrically linked by structure 37 to the driven plate 38. Other components are similar to FIGS. 2A and B.

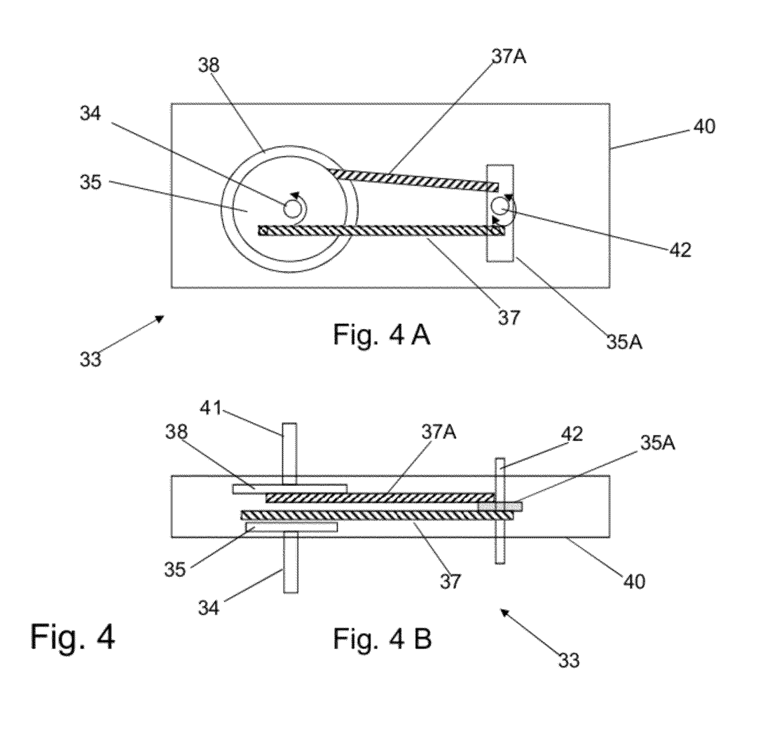

FIGS. 4A and 4B are sketches of an alternative embodiment 33 of the reciprocating or oscillating drive device with an inline drive 34 and driven means 41. The device 33 uses an eccentric bar 37 rotatably connected to a drive plate 35 and an intermediate linkage bar 35A. This intermediate linkage bar 35A is rotatably supported in the encasement 40 by a support means 42. The intermediate linkage 35A is then rotatably linked by a secondary linkage 37A. This secondary linkage 37A is in turn rotatably connected to the reciprocating driven member 38 or structure which in turn is secured to the driven output means 41 such as a shaft. In all the cases of reciprocating devices above, a drill bit of at least three flutes has empirically provided a precision hole as opposed to less fluted bits.

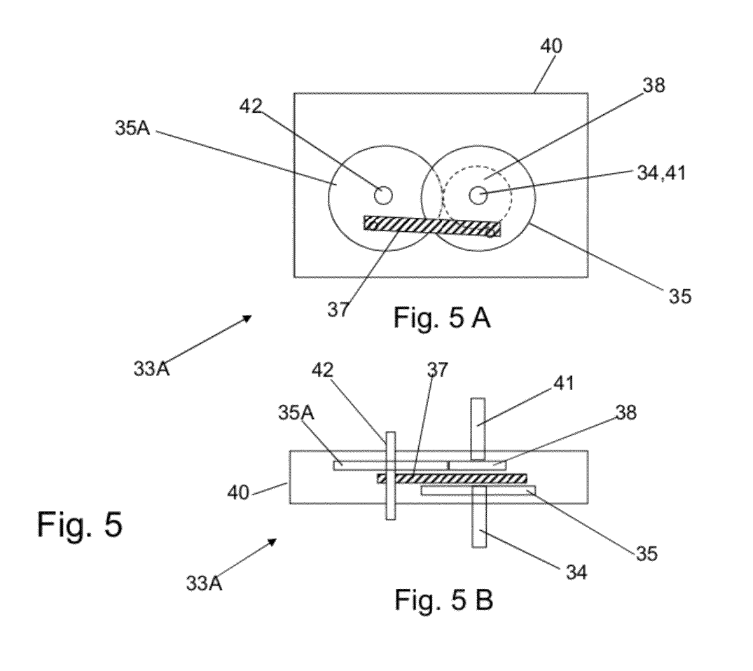

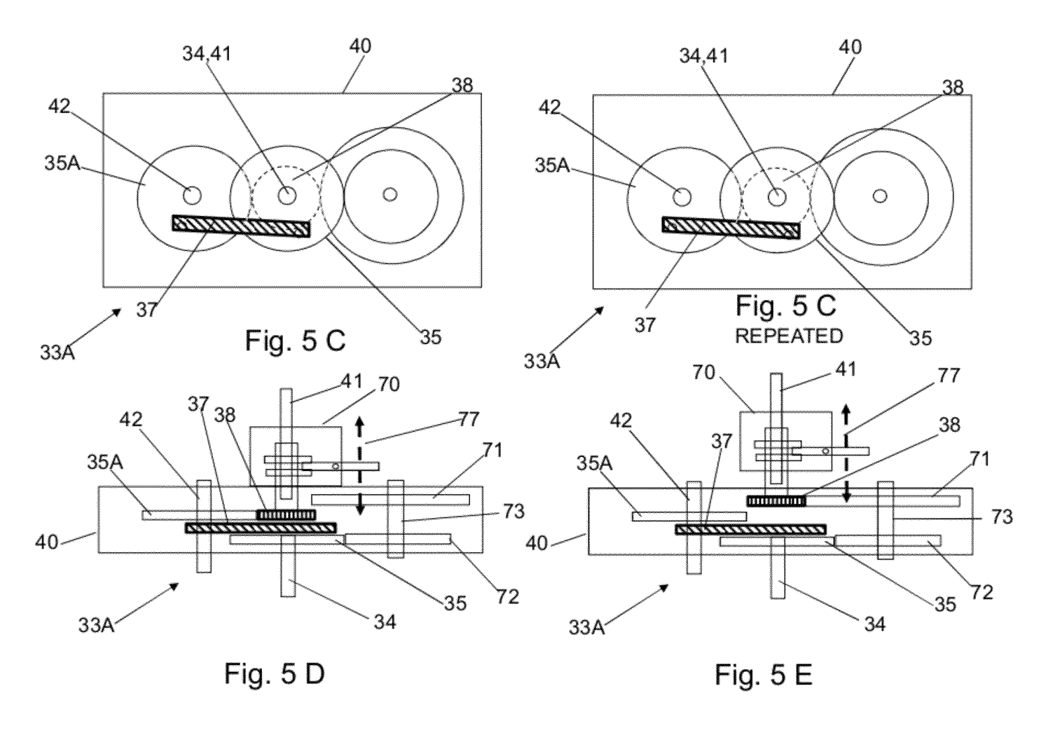

FIGS. 5A through 5E are sketches of the oscillating or reciprocating drive device—inline drive, gears and eccentric bars and combination reciprocating drive and continuous drive sub-system. FIGS. 5A and 5B are sketches of an alternative embodiment 33A of the reciprocating drive device with an inline drive 34 and driven means 41. The device 33A uses an eccentric bar 37 rotatably connected to a drive plate 35 and an intermediate linkage gear 35A. This intermediate gear 35A is rotatably supported in the encasement 40 by a support means 42. The intermediate linkage gear 35A is then directly engaged with a driven gear 38. The reciprocating driven member 38 is in turn secured to the driven output means 41 such as a shaft. FIGS. 5C, 5D and 5E show the versatile alternative embodiment with the reciprocating drive linked with a continuous drive transmission (clockwise or counter clockwise. This configuration is a means of drilling into hard material covered in softer material without having to remove or significantly alter the soft covering. In other words it allows for the placement of a securing device or for the passing of wires, pipes, ventilation, etc. in applications where a singular oscillating device or singular continuous drive is not feasible. Here the sketches add a transmission 70 with longitudinal adjust for the output shaft, a Continuous Drive output gear 71, a Continuous Drive input gear 72, a continuous Drive shaft 73. The Shift movement 77 for oscillating/continuous drive transmission system is also shown when the system is engaged as a reciprocating drive (FIG. 5D) and when the system is a continuous drive (FIG. 5E). One sees that the transmission 70 permits a shift from either mode. One also noted the continuous mode may be clock-wise or counter clockwise.

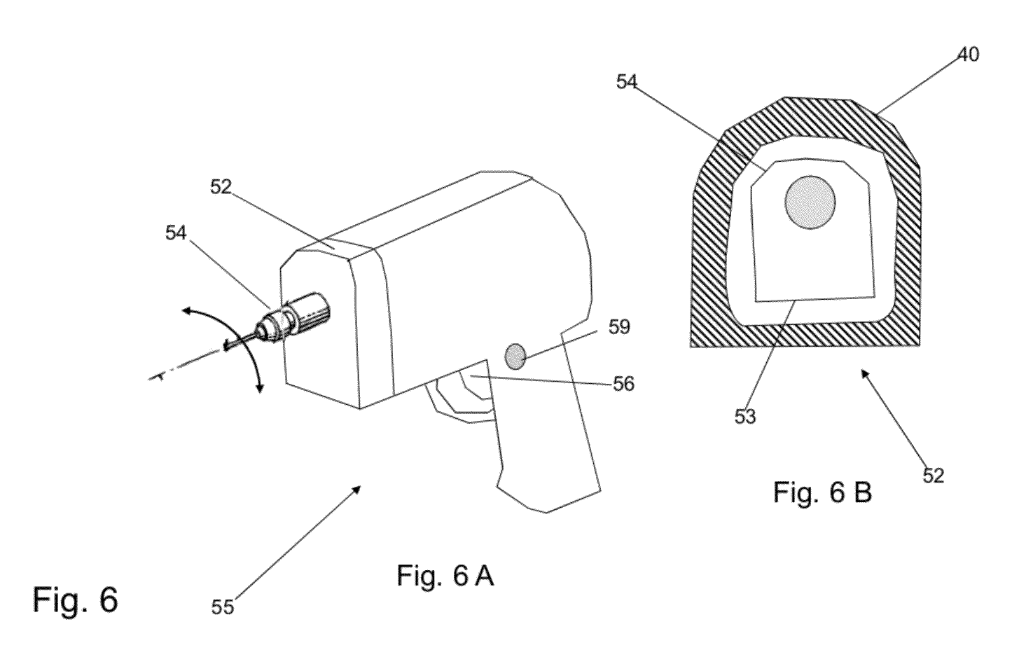

FIGS. 6A and 6B are sketches of the electronic controlled reciprocating (oscillating) turning device 55 such as a drill or the like. The out put tool chuck means 54 is connected to the electronically controlled reciprocating component 52. This component 52 produces a reciprocating output by means of the electronic control device 53. One skilled in the electronic controls field well appreciates the plethora of control designs capable of providing this reciprocating control from the straight drive through the electronic control 53. All this is activated by the operating switch 56. One also sees the alternative embodiment of a reversing switch 59. The system alternatively may have a means for controlling the power source such as an electronic controller. This would provide an oscillation power pulse or presence of power to the drive and an alternative continuous pulse to the drive by means of a simple switch. Another embodiment would be a system wherein the continuous power may provide a choice of a clockwise and a counterclockwise motion of the drive.

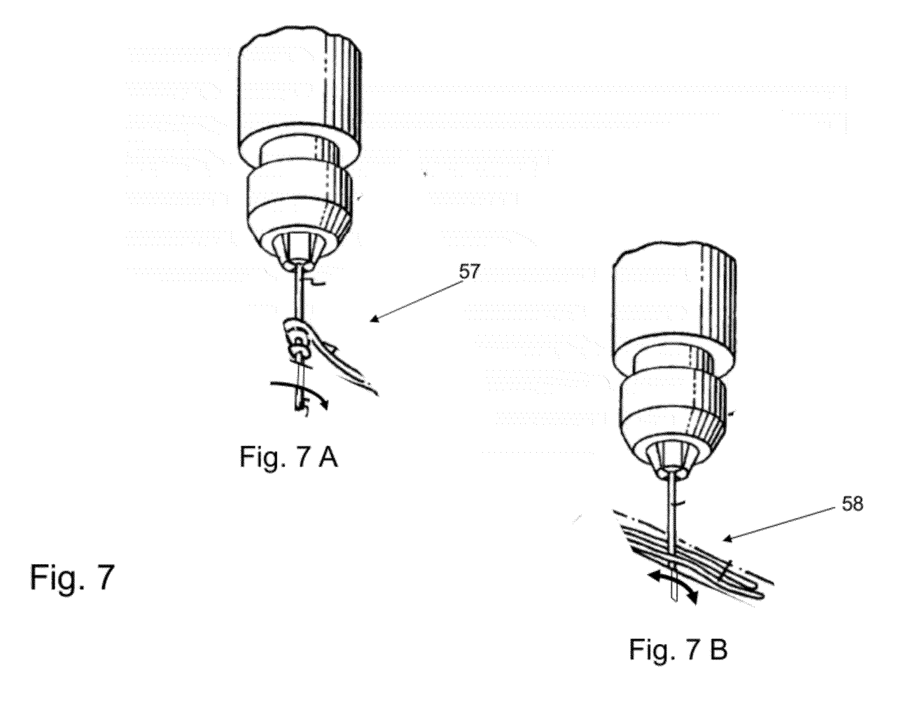

FIGS. 7A and 7B are sketches that show The problem addressed. This is discussed in the operation section below.

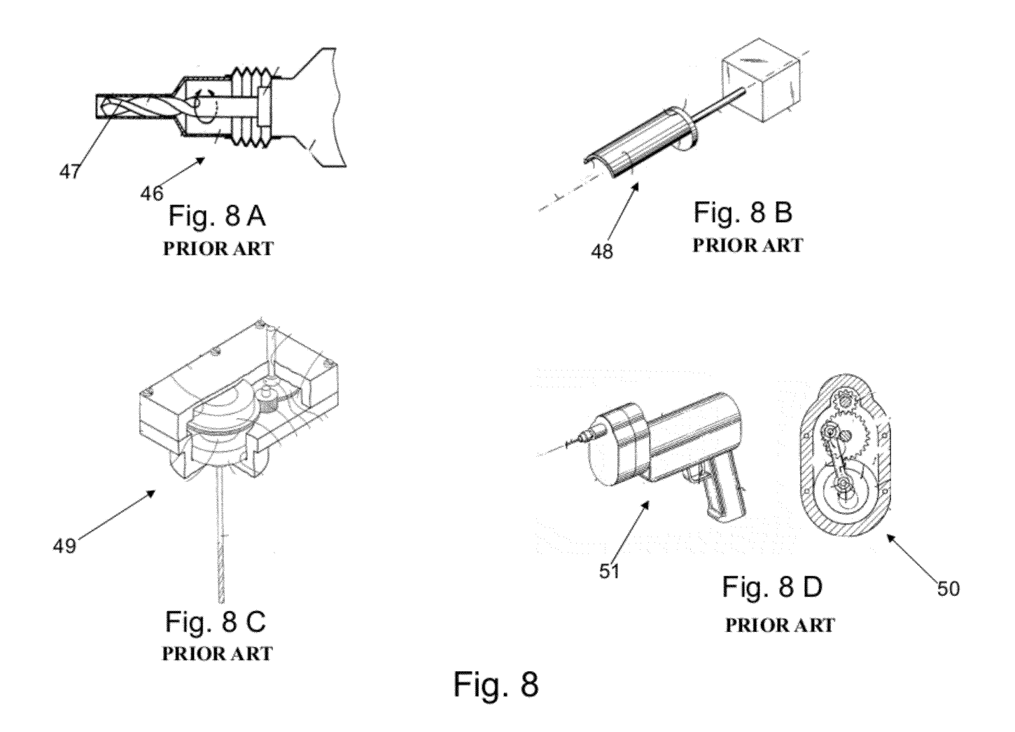

FIGS. 8A through 8D are prior art of other turning and reciprocating devices. U.S. Pat. No. 4,111,208 shown in FIG. 8A teaches a process and apparatus for drilling holes in hard materials in surgical procedures. U.S. Pat. No. 4,955,888 shown in FIG. 8B teaches a biradial saw. U.S. Pat. No. 5,030,222 shown in FIG. 8C teaches a radiolucent orthopedic chuck A Method of fixating bone by driving a wire through oscillation was taught by the U.S. Pat. No. 6,110,174 (FIG. 8D).

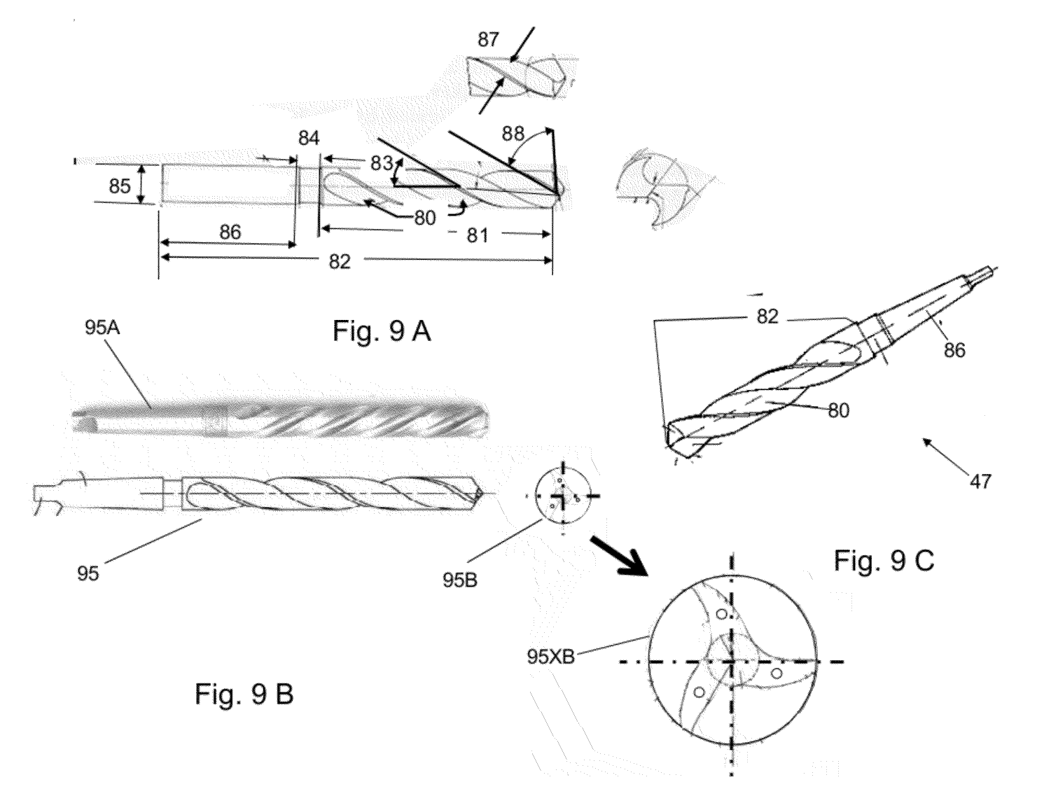

FIGS. 9A through 9C are tooling option specifics to drill bits. In FIGS. 9A and 9C are shown the general fluted drill and its features. Included are: the flutes 80; flute length 81; body length 82; helix angle 83; neck 84; shank diameter 85; shank length 86; land width 87; point angle 88; and a multi fluted drill. In FIG. 9A is shown: a three fluted drill 95, a three fluted drill part photo to sketch 95A a three fluted drill end view with flutes 95B and a three fluted drill expanded end view 95XB. One skilled in the art of drills understands that a minimum of at least three flutes on the drill means a more accurate and faster ability to produce the hole. A three-flute design spreads cutting loads over a larger area so holes are cleaner and rounder. The bit itself will last longer too. Materials designed for cutting hard metals include: stainless, nickel steel alloys, titanium plus. These perform great on soft metals too. For the Universal bits, these drill bits can be used in wood, metal, plastic, and most other materials. The twist drill bit is the type produced in largest quantity today. It comprises a cutting point at the tip of a cylindrical shaft with helical flutes; the flutes act as an Archimedean screw and lift swarf out of the hole. The original method of manufacture was to cut two grooves in opposite sides of a round bar, then to twist the bar (giving the tool its name) to produce the helical flutes. Nowadays, the drill bit is usually made by rotating the bar while moving it past a grinding wheel to cut the flutes in the same manner as cutting helical gears. Further, manufacturers can produce special versions of the twist drill bit, varying the geometry and the materials used, to suit particular machinery and particular materials to be cut. Using an ordinary two-flute twist drill bit to enlarge the hole resulting from a material object will not normally produce as clean of a result—the result will possibly be out of round, off center and generally of poor finish. The two fluted drill bit also has a tendency to grab on any protuberance (such as flash) which may occur in the product. Multiple flutes such as 3 or four fluted drills improve the results dramatically and improve the trueness or precision of the hole.

TABLE C
Classification Based on Number of Flutes

| Item | Name | Comment |
|---|---|---|
| 1 | Two-Flute Drills | The conventional type of twist drill |
| | | used for originating holes |
| 2 | Single-Flute | Those having only one flute commonly |
| | Drills | used for originating holes |
| 3 | Three-Flute Drills | Drills commonly used for enlarging |
| | | and finishing, drilled, cast, or |
| | | punched holes. They can produce |
| | | original holes whereas a reamer does |
| | | not. |
| 4 | Four-Flute Drills | Used interchangeably with three- |
| | | flute drills; they are of similar |
| | | construction except for the number |
| | | of flutes |
| 5 | Drill | Drill can be defined as a rotary end |
| | | cutting tool having one or more |
| | | cutting lips, and having one or more |
| | | helical or straight flutes for the |
| | | passage of chips and the admission |
| | | of a cutting fluid. |
| 6 | Helical Flutes | Flutes which are formed in a helical |
| | | path around the axis |

One skilled in the art of drill and turning devices appreciates that these oscillating devices and process for drilling holes in soft materials 31, 32, 33 and 33A may be made of various materials. Often, these devices are combinations of materials to keep the designs simple and to lower the costs. Various metals, plastics and composite materials may be used for the main eccentric, disk or gear structures 35, 35A, 36, 37, 37A, and 38. Various thrust bearing or ball bearing devices may provide the connection means 39 (such as a thrust bearing or the like) of members to an encasement 40. The encasement 40 may be of metals (such as aluminum, steel and the like), plastics and composite materials structures. These may be stamped, molded or cast depending on the selected material and final design configuration. The input and output means 34 and 41 can be of various metals, composites and plastics also and be within the scope and spirit of the device and system.

All of the details mentioned here are exemplary and not limiting. Other specific components specific to describing an oscillating device and process for drilling holes in soft materials 31, 32, 33, 33A may be added as a person having ordinary skill in the field of drilling and turning devices well appreciates.

### Operation of the Preferred Embodiment

The new oscillating device and process for drilling holes in soft materials 31, 32, 33, and 33A have been described in the above embodiment. The manner of how the device operates is described below. One skilled in the art of drill and turning devices will note that the description above and the operation described here must be taken together to fully illustrate the concept of the special drilling device and system. The preferred embodiment is a general reciprocating drive system 31 made of durable material comprising (a) a reciprocating drive means 32 for transferring rotational movement to reciprocating movement comprising: i. a direct rotational drive means 34 for imparting rotational movement to the system 31; ii. a means for connecting 34A the direct rotational drive means 34 to the system 31; iii. a transfer means 35 inter-placed between the direct rotation drive and a reciprocation means 41; iv. a reciprocation means 36 for transforming rotational movement to reciprocating movement; v. an output means to connect 41 for supplying reciprocating movement; and vi. a means for connecting the output to a tool 41A; (b) a durable encasement 40; (c) a means for connecting 39 the components of the drive means 31 to the encasement means 40; and (d) a means 45 for holding the encasement whereby the rotational drive motion is smoothly transferred into a reciprocating motion to use for turning and drilling soft materials by a person P operating the system. One skilled in the art of drilling and turning devices and systems will appreciate the plethora and varied uses anticipated by this new drilling device and system.

Potential uses for this device with the drilling and turning industry as described herein. However, these describe uses are exemplary and not intended as a limitation of anticipated uses for the drilling device and system. The following TABLE D shows additional examples of potential turning and drilling uses.

TABLE D
POSSIBLE TURNING AND DRILLING USES

| ITEM | DESCRIPTION |
|---|---|
| 1 | Carpet and rugs |
| 2 | Foam rubber |
| 3 | Fibrous mats |
| 4 | Quilted materials |
| 5 | Upholstery |
| 6 | Fabrics |
| 7 | Insulations |
| 8 | High splinter wood |
| 9 | Soft wood such as balsa |

Beyond the potential uses, the improved method of operation is shown in FIGS. 7A and 7B. FIG. 7A shows the traditional turning a full 360 degrees and the resultant soft material or fiber being caught and wrapped around the tool—here a drill bit. FIG. 7B shows the improved operation where the reciprocating tool goes through layers of material without wrapping the material around the tool. The improvement may be well appreciated for those skilled in the art of turning or boring through soft materials such as illustrated above. This expansion of use has not been taught or claimed in other publications or patents as far as the search of intellectual property and trade publications

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless they are defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other of the embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

Unless they are otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

With the above description and accompanying drawings, it is to be understood that the drilling device and system 31 is not to be limited to only the disclosed embodiment. The features of the drilling device and system 31 are intended to cover various modifications and equivalent arrangements included within the spirit and scope of the description.

What is claimed is:

1. A general reciprocating drive system 31 made of durable material comprising:
(a) a reciprocating drive means (32) for transferring rotational movement to reciprocating movement comprising:
i. a direct rotational drive means (34) for imparting rotational movement to the system (31);
ii. a means for connecting (34A) the direct rotational drive means (34) to the system (31);
iii. a transfer means (35) inter-placed between the direct rotation drive and a reciprocation means (41);
iv. a reciprocation means (36) for transforming rotational movement to reciprocating movement;
v. an output means to connect (41) for supplying reciprocating movement; and
vi. a means for connecting the output to a tool (41A);
(b) a durable encasement (40);
(c) a means for connecting (39) the components of the drive means (31) to the encasement means (40); and
(d) a means (45) for holding the encasement
whereby the rotational drive motion is smoothly transferred into a reciprocating motion to use for turning and drilling soft materials by a person (P) operating the system.

2. The system according to claim 1 wherein the direct rotational drive means (34) is comprising:
(a) a power source,
(b) a means for controlling the power source,
(c) a rotating drive motor, and
(d) a means for completing an electrical connection the power source and the controlling means to the electrical motor.

3. The system according to claim 2 wherein the durable material is a metal.

4. The system according to claim 3 wherein the metal is steel.

5. The system according to claim 3 wherein the metal is aluminum.

6. The system according to claim 2 wherein the durable material is a composite material.

7. The system according to claim 6 wherein the composite material is a plastic.

8. The system according to claim 2 wherein the reciprocation means (36) a configuration of more than one gear and an eccentric bar connected to a gear and the output means (41).

9. The system according to claim 2 wherein the reciprocation means (36) is a configuration of more than one eccentric bars, the first bar connected to the input means (34A) and the last bar connected to the output means (41).

10. The system according to claim 2 wherein the reciprocation means (36) is a configuration of more than one eccentric bars, the first bar connected to the input means (34A) and the last bar connected to the output means (41).

11. The system according to claim 2 wherein the means for controlling the power source is an electronic controller that provides an oscillation power pulse to the drive and an alternative continuous pulse to the drive by means of a simple switch.

12. The system according to claim 11 wherein the continuous power may provide a choice of a clockwise and a counterclockwise motion of the drive.

13. A general reciprocating drive system (31) made of durable material comprising:
(a) a direct rotational drive means (34) for transferring rotational movement to reciprocating movement;
(b) a drive shaft (34A);
(c) a direct rotational drive plate (35);
(d) a means for securing the drive shaft (34A) to the rotational plate (35);
(e) an eccentric bar (37) with two ends;
(f) a driven plate (38);
(g) a means for connecting the bar (37) eccentrically and rotatably at each end of the bar in a rotatable connection, one end connected to the drive plate (35) and the opposite end to the driven plate (38);
(h) an output means to connect (41) for supplying reciprocating movement;
(i) a means for connecting the output to a tool (41A);
(j) an encasement (40); and
(k) a means (39) for holding the components of the system interior to the encasement.
whereby the rotational drive motion is smoothly transferred into a reciprocating motion to use for turning and drilling soft materials by a person (P) operating the system.
